(19) United States
(12) Patent Application Publication
(10) Pub. No.: US 2015/0004051 A1
(43) Pub. Date: Jan. 1, 2015

(54) SPRING STEEL

(71) Applicant: JFE Steel Corporation, Tokyo (JP)

(72) Inventors: Minoru Honjo, Tokyo (JP); Kiyoshi Uwai, Tokyo (JP); Shinji Mitao, Tokyo (JP)

(21) Appl. No.: 14/378,210

(22) PCT Filed: Feb. 14, 2013
(86) PCT No.: PCT/JP2013/054248

§ 371 Date: Aug. 12, 2014

(30) Foreign Application Priority Data
Feb. 14, 2012 (JP) 2012-029893
Sep. 28, 2012 (JP) 2012-217484

(51) Int. Cl. C22C 38/60; C22C 38/22; C22C 38/24; C22C 38/26; C22C 38/28; C22C 38/32; C22C 38/34; C22C 38/04; C22C 38/42; C22C 38/44; C22C 38/46; C22C 38/48; C22C 38/50; C22C 38/54; F16F 1/02; C22C 38/20

(52) U.S. Cl. CPC C22C 38/60; C22C 38/20; C22C 38/22; C22C 38/24; C22C 38/26; C22C 38/28; C22C 38/32; C22C 38/34; C22C 38/04; C22C 38/42; C22C 38/44; C22C 38/46; C22C 38/48; C22C 38/50; C22C 38/54; F16F 1/021
USPC 420/106; 420/105; 420/108; 420/110; 420/111; 420/109

(57) ABSTRACT

A high strength spring steel suppresses ferrite decarburization in a surface layer of a predetermined wire rod manufactured by hot rolling therefrom and possesses excellent decarburization resistance, as compared to conventional high strength spring steel, by optimizing the amount of C, Si, Mn, Cr, Mo and Sb to be added. The spring steel contains, under a certain relationship: 0.35 mass %≦C≦0.45 mass %; 1.75 mass %≦Si≦2.40 mass %; 0.1 mass %≦Mn≦1.0 mass %; 0.01 mass %≦Cr<0.50 mass %; 0.01 mass %≦Mo≦1.00 mass %; P≦0.025 mass %; S≦0.025 mass %; and O≦0.0015 mass %; and at least one selected from 0.035 mass %≦Sb≦0.12 mass % and 0.035 mass %≦Sn≦0.20 mass %.

### TECHNICAL FIELD

This disclosure relates to high strength spring steel used as the material of, e.g., suspension springs, torsion bars and stabilizers for automobiles and, in particular, to spring steel that possesses high strength as well as excellent decarburization resistance and suitably used for underbody parts of automobiles.

### BACKGROUND ART

As the demand to improve fuel efficiency of automobiles and reducing carbon dioxide emission grows from the viewpoint of recent global environmental issues, there is an increasingly high demand to reduce the weight of automobiles. Particularly, there is a strong demand to reduce the weight of suspension springs as underbody parts of automobiles, whereby high stress design is applied to these suspension springs by using as a material thereof a strengthened material having a post quenching-tempering strength of 2000 MPa or more.

General-purpose spring steel has a post quenching-tempering strength of 1600 MPa to 1800 MPa or so, as prescribed in JIS G4801. Such spring steel is manufactured into a predetermined wire rod by hot rolling. Then, in a hot-formed spring, the wire rod is thermally formed into a spring-like shape and subjected to subsequent quenching-tempering processes. Alternatively, in a cold formed spring, the wire rod is subjected to drawing and subsequent quenching-tempering processes before being formed into a spring-like shape.

For example, commonly used materials for suspension springs include SUP7 described in JIS G4801. SUP7, which contains Si in an amount of 1.8 mass % to 2.2 mass %, makes a surface layer susceptible to decarburization, especially ferrite decarburization, when manufactured into a predetermined wire rod by hot rolling, which should adversely affect the properties (e.g., fatigue properties) of the resulting springs. Ferrite decarburization is a phenomenon in which austenite phase transforms to ferrite phase in association with decarburization, and caused by decarburization of surfaces of a steel material occurring when the steel material is subjected to process steps such as heating or hot rolling steps, as well as other process steps such as hot forming or quenching where a steel wire rod is heated. Since suppressing this ferrite decarburization is beneficial not only to ensure the fatigue properties of the resulting springs, but also to eliminate the need to perform a peeling step or the like to remove any decarburized layers, improving yields, and so on. As such, various approaches have been proposed to suppress ferrite decarburization

For example, JP 2003-105496 A discloses a technique to suppress ferrite decarburization by controlling the total content of Cu and Ni (Cu+Ni). However, since ferrite decarburization is a phenomenon in which the amount of carbon decreases in a surface layer region of the steel material so that the surface layer region has ferrite single-phase structure, it is difficult to surely suppress ferrite decarburization even by controlling the content of Cu+Ni in the range of 0.20 mass % to 0.75 mass %.

JP 2009-068030 A discloses a steel wire rod for springs having excellent decarburization resistance and wire drawability obtained by controlling the content of C, Si, Mn, Cr, P and S and controlling the crystal grain size of a wire rod. However, since ferrite decarburization is a phenomenon in which the amount of carbon decreases in a surface layer region of the steel material so that the surface layer region has ferrite single-phase structure, it is difficult to surely suppress ferrite decarburization even by controlling the crystal grain size of the wire rod while adjusting the content of C, Si, Mn, Cr, P and S.

JP 2003-268453 A discloses a technique to suppress ferrite decarburization by terminating the finish rolling when the surface temperature reaches a temperature range of 800° C. to 1000° C., coiling the steel wire after rolling in the form of a coil without subjecting the steel wire to water cooling before coiling, and at a cooling step after the coiling, cooling the steel wire at a rate equal to or lower than that of air cooling, without rapidly changing the cooling conditions, until the transformation is finished. However, since ferrite decarburization is a phenomenon in which the amount of carbon decreases in a surface layer region of the steel material so that the surface layer region has ferrite single-phase structure, it is difficult to suppress ferrite decarburization by controlling the manufacturing conditions alone.

JP 8-176737 A discloses a technique to reduce decarburization by controlling the amount to combine minor constituents, Ni, Cu and S, normally contained in the steel in manufacturing spring steel. However, since ferrite decarburization is a phenomenon in which the amount of carbon decreases in a surface layer region of the steel material so that the surface layer region has ferrite single-phase structure, it is difficult to surely avoid a reduction in the amount of carbon in the surface layer region even by controlling the amount to combine Ni, Cu and S, in which case it is difficult to suppress ferrite decarburization.

JP 6-072282 B discloses a technique to suppress ferrite decarburization by controlling the content of C, Si, Mn and Sb. JP '282 discloses an example of a steel containing 0.55 mass % or more of C, which is advantageous in suppressing ferrite decarburization because of a large amount of C added in the steel. However, this technique still has difficulties in suppressing decarburization (in JP '282, total decarburization) and avoiding deterioration in wire drawability due to a large amount of C and Sb contained in the steel, although it can suppress ferrite decarburization.

As described above, further strengthening of suspension springs as underbody parts of automobiles has been desired in terms of improving fuel efficiency of automobiles and reducing carbon dioxide emission. However, any ferrite decarburization in a surface layer of a spring adversely affects the properties (e.g., fatigue properties) of the spring, there has been a problem associated with suppression of ferrite decarburization (which will also be referred to as “decarburization resistance”). In addition, another problem that has been raised is that due to an increase in C content and addition of alloy elements such as Cu, Ni or Sb, a spring material before wire drawing becomes susceptible to generation of a hard phase and, therefore, it has lower wire drawability.

It could therefore be helpful to provide a spring steel possessing higher strength and better decarburization resistance without impairing the properties of the spring steel, as compared to conventional high strength spring steel, by controlling the amount of C, Si, Mn, Cr, Mo, Sb and Sn to be added.

### SUMMARY

We found that it is possible to provide a material with improved decarburization resistance and wire draw-ability while maintaining the properties thereof required for springs, by controlling the amount of C, Si, Mn, Cr, Mo, Sb and Sn to be added, respectively, and by using an alloy design such that a DF value represented by formula (1) given below, a DT value represented by formula (2) below, and a WD value represented by formula (3) below fall within the appropriate range.

Specifically, we provide:
[1] A spring steel comprising a chemical composition containing:
   C: 0.35 mass % or more and 0.45 mass % or less,
   Si: 1.75 mass % or more and 2.40 mass % or less,
   Mn: 0.1 mass % or more and 1.0 mass % or less,
   Cr: 0.01 mass % or more and less than 0.50 mass %,
   Mo: 0.01 mass % or more and 1.00 mass % or less,
   P: 0.025 mass % or less,
   S: 0.025 mass % or less,
   O: 0.0015 mass % or less, and
   at least one selected from:
      Sb: 0.035 mass % or more and 0.12 mass % or less and
      Sn: 0.035 mass % or more and 0.20 mass % or less,
   under conditions that
      a DF value calculated by the following formula (1) is 0.23 or more and 1.50 or less,
      a DT value calculated by the following formula (2) is 0.34 or more and 0.46 or less, and
      a WD value calculated by the following formula (3) is not more than 255; and
   the balance being Fe and incidental impurities,

DF=[Si]/{100×[C]×([Sn]+[Sb])} (1)

DT=10×[C]/{5×[Si]+2×[Sn]+3×[Sb]} (2)

WD=544×[C]+188×[Sn+Sb] (3),

where [brackets] denote the content of an element in the brackets in mass %.
[2] The spring steel according to [1] above, wherein the chemical composition further contains at least one element selected from
   Al: 0.50 mass % or less,
   Cu: 1.0 mass % or less, and
   Ni: 2.0 mass % or less.
[3] The spring steel according to [1] or [2] above, wherein the chemical composition further contains at least one element selected from
   W: 2.0 mass % or less,
   Nb: 0.1 mass % or less,
   Ti: 0.2 mass % or less, and
   V: 0.5 mass % or less.
[4] The spring steel according to any one of [1] to [3] above, wherein the chemical composition further contains
   B: 0.005 mass % or less.

It is possible to provide a high strength spring steel in a stable manner possessing much better decarburization resistance and wire drawability than conventional high strength spring steel.

### BRIEF DESCRIPTION OF THE DRAWINGS

Our spring steels will be further described below with reference to the accompanying drawings.

FIG. 1 illustrates the evaluation results of decarburization resistance as a function of the DF value.

FIG. 2 is a graph summarizing the evaluation results of wire drawability as a function of the WD value.

FIG. 3 is an image of a metal structure where a ferrite decarburized layer is generated in a surface layer.

FIG. 4 is an image of a metal structure where a ferrite decarburized layer is not generated in a surface layer.

FIG. 5 is an image of a metal structure where a decarburized layer, which is not a ferrite decarburized layer, is generated in a surface layer.

### DETAILED DESCRIPTION

Our spring steels will be described in detail below. First, a chemical composition of the high strength spring steel will be described.

0.35 mass %≦C≦0.45 mass %

Carbon (C) is an element essential to ensure the required strength of the steel. If C content in the steel is less than 0.35 mass %, it is difficult to ensure a predetermined strength, or it is necessary to add a large amount of alloy elements to ensure a predetermined strength, which leads to an increase in alloy cost. Accordingly, the C content is 0.35 mass % or more. Additionally, the lower the C content, the more the steel is susceptible to generation of ferrite decarburization. On the other hand, C content exceeding 0.45 mass % leads to degradation in toughness, as well as deterioration in wire drawability of a wire rod during hardening and wire drawing. In view of the above, the C content is 0.35 mass % or more and 0.45 mass % or less, preferably 0.36 mass % or more and 0.45 mass % or less.

1.75 mass %≦Si≦2.40 mass %

Silicon (Si) is an element that improves the strength and sag resistance of the steel when used as a deoxidizer, and through solid solution strengthening and enhancement of resistance to temper softening. Si is added to the steel in an amount of 1.75 mass % or more. However, if added in an amount exceeding 2.40 mass %, Si causes ferrite decarburization in manufacturing springs. Accordingly, the upper limit of Si is 2.40 mass %. In view of the above, the Si content is 1.75 mass % or more and 2.40 mass % or less, preferably 1.80 mass % or more and 2.35 mass % or less.

0.1 mass %≦Mn≦1.0 mass %

Manganese (Mn) is an element useful to improve the quench hardenability of the steel and enhancing the strength thereof. Accordingly, Mn is added to the steel in an amount of 0.1 mass % or more. However, if Mn is added to the steel in an amount greater than 1.0 mass %, the steel is excessively strengthened, leading to a reduction in the toughness of the base steel. Accordingly, the upper limit of Mn is 1.0 mass %. In view of the above, the Mn content is 0.1 mass % or more and 1.0 mass % or less, preferably 0.2 mass % or more and 1.0 mass % or less.

P≦0.025 mass %
S≦0.025 mass %

Phosphorus (P) and sulfur (S) are elements segregated at grain boundaries and cause a reduction in the toughness of the base steel. It is preferable that these elements are reduced as much as possible. Accordingly, P and S are contained in the steel in an amount of 0.025 mass % or less, respectively. Since it is costly to reduce the content of each element to less than 0.0002 mass %, industrially speaking, the content of each element only needs to be reduced to 0.0002 mass %.

0.01 mass %≦Cr<0.50 mass %

Chromium (Cr) is an element that improves the quench hardenability of the steel and enhances the strength thereof. Accordingly, Cr is added to the steel in an amount of 0.01 mass % or more. However, if Cr is added to the steel in an amount of 0.50 mass % or more, the steel is excessively strengthened, leading to a reduction in the toughness of the base steel. In addition, Cr is an element that reduces pitting corrosion resistance as it causes a drop in the pH at the pit bottom. In view of the above, the Cr content is 0.01 mass % or more and less than 0.50 mass %, preferably 0.01 mass % or more and 0.49 mass % or less.

0.01 mass %≦Mo≦1.00 mass %

Molybdenum (Mo) is an element that improves the quench hardenability and post-tempering strength of the steel. To obtain this effect, Mo is added to the steel in an amount of 0.01 mass % or more. However, if added in an amount exceeding 1.00 mass %, the addition of Mo leads to an increase in alloy cost. In this case, the steel is excessively strengthened, leading to a reduction in the toughness of the base steel. In view of the above, the Mo content is 0.01 mass % or more and 1.00 mass % or less, preferably 0.01 mass % or more and 0.95 mass % or less.

0.035 mass %≦Sb≦0.12 mass %

Antimony (Sb) is an element that concentrates in a surface layer, inhibits dispersion of C from the steel and suppresses a reduction in the C content in the surface layer. Sb needs to be added to the steel in an amount of 0.035 mass % or more. However, if added in an amount exceeding 0.12 mass %, Sb would be segregated in the steel, which leads to deterioration in the toughness of the base steel and degradation in the wire drawability. In addition, addition of Sb increases the quench hardenability of wires and generates hard phases such as bainite or martensite, which lowers the wire drawability during drawing. In view of the above, the Sb content is 0.035 mass % to 0.12 mass %, more preferably 0.035 mass % to 0.115 mass %.

0.035 mass %≦Sn≦0.20 mass %

Tin (Sn) is an element that concentrates in a surface layer, inhibits dispersion of C from the steel. Sn needs to be added to the steel in an amount of 0.035 mass % or more. However, if added in an amount exceeding 0.20 mass %, Sn would be segregated in the steel, which may lead to degradation in the properties of the resulting springs. In addition, addition of Sn increases the quench hardenability of wires and generates hard phases such as bainite or martensite, which lowers the wire drawability during drawing. In view of the above, the Sn content is 0.20 mass % or less, more preferably 0.035 mass % to 0.195 mass %.

Our spring steels also encompass situations where either of Sb or Sn is not intentionally added to the steel. If Sb is not added intentionally, Sb is contained in the steel as an incidental impurity in an amount of less than 0.01 mass %. If Sn is not added intentionally, Sn is contained in the steel as an incidental impurity in an amount of less than 0.01 mass %. In the formula (1) above, used as Sb content [Sb] and Sn content [Sn] are the amount of Sb and/or the amount of Sn contained in the steel as an incidental impurity or incidental impurities (in mass %), or when added intentionally, the amount of Sb and the amount of Sn intentionally added to the steel (in mass %).

O≦0.0015 mass %

Oxygen (O) is an element bonded to Si or Al to form a hard oxide-based non-metal inclusion, which leads to deterioration in the properties of the resulting springs. Thus, lower O content gives a better result. However, up to 0.0015 mass % is acceptable.

0.23≦DF value (Formula (1))≦1.50
0.34≦DT value (Formula (2))≦0.46
WD value (Formula (3))≦255

The experimental results from which the DF value, DT value and WD value were derived will now be described in detail below.

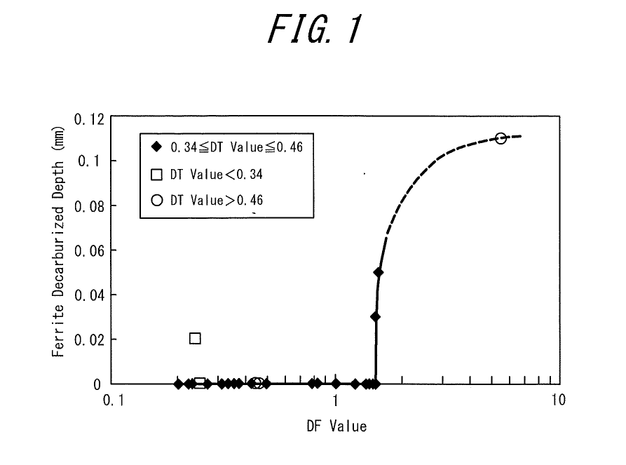

Specifically, we fabricated spring steel samples with different chemical compositions, DF values, DT values and WD values as shown in Table 1, and evaluated the decarburization resistance, toughness and wire drawability of the respective samples. The evaluation results are shown in Table 2. The evaluation results on decarburization resistance are also summarized in FIG. 1 as a function of DF value. In Table 1, the value of each element represents its content (in mass %).

TABLE 1

| Steel | | | | | | | | | | | DF | DT | WD | |
|---|---|---|---|---|---|---|---|---|---|---|---|---|---|---|
| No. | C | Si | Mn | P | S | Cr | Mo | Sn | Sb | O | Value | Value | Value | Remarks |
| A-1 | 0.60 | 2.00 | 0.85 | 0.020 | 0.015 | — | — | 0.001 | 0.005 | 0.0010 | 5.56 | 0.60 | 333 | Reference Steel |
| A-2 | 0.42 | 2.01 | 0.88 | 0.005 | 0.006 | 0.04 | 0.20 | 0.005 | 0.100 | 0.0009 | 0.46 | 0.41 | 245 | Inventive Steel |
| A-3 | 0.38 | 1.76 | 0.85 | 0.006 | 0.005 | 0.04 | 0.18 | 0.005 | 0.090 | 0.0008 | 0.49 | 0.42 | 222 | Inventive Steel |
| A-4 | 0.44 | 1.91 | 0.21 | 0.007 | 0.007 | 0.03 | 0.11 | 0.005 | 0.051 | 0.0007 | 0.78 | 0.45 | 250 | Inventive Steel |
| A-5 | 0.39 | 1.98 | 0.30 | 0.009 | 0.005 | 0.49 | 0.05 | 0.001 | 0.035 | 0.0008 | 1.41 | 0.39 | 220 | Inventive Steel |
| A-6 | 0.42 | 1.90 | 0.41 | 0.008 | 0.004 | 0.49 | 0.25 | 0.001 | 0.120 | 0.0006 | 0.37 | 0.43 | 247 | Inventive Steel |
| A-7 | 0.41 | 2.22 | 0.77 | 0.006 | 0.005 | 0.21 | 0.20 | 0.050 | 0.080 | 0.0007 | 0.42 | 0.36 | 242 | Inventive Steel |
| A-8 | 0.39 | 1.94 | 0.65 | 0.008 | 0.004 | 0.45 | 0.18 | 0.150 | 0.035 | 0.0008 | 0.27 | 0.39 | 238 | Inventive Steel |
| A-9 | 0.42 | 2.39 | 0.50 | 0.007 | 0.005 | 0.48 | 0.15 | 0.111 | 0.062 | 0.0006 | 0.33 | 0.34 | 253 | Inventive Steel |
| A-10 | 0.39 | 2.28 | 0.95 | 0.008 | 0.006 | 0.35 | 0.10 | 0.018 | 0.040 | 0.0007 | 1.01 | 0.34 | 223 | Inventive Steel |
| A-11 | 0.37 | 2.01 | 0.35 | 0.007 | 0.007 | 0.33 | 0.17 | 0.200 | 0.035 | 0.0008 | 0.23 | 0.35 | 233 | Inventive Steel |
| A-12 | 0.42 | 1.85 | 0.65 | 0.008 | 0.007 | 0.15 | 0.15 | 0.001 | 0.035 | 0.0007 | 1.22 | 0.45 | 237 | Inventive Steel |
| A-13 | 0.41 | 1.76 | 0.54 | 0.007 | 0.005 | 0.22 | 0.11 | 0.001 | 0.051 | 0.0006 | 0.83 | 0.46 | 233 | Inventive Steel |
| A-14 | 0.42 | 2.40 | 0.41 | 0.006 | 0.005 | 0.49 | 0.05 | 0.001 | 0.037 | 0.0007 | 1.50 | 0.35 | 237 | Inventive Steel |
| A-15 | 0.39 | 1.75 | 0.21 | 0.005 | 0.004 | 0.25 | 0.15 | 0.110 | 0.120 | 0.0008 | 0.20 | 0.42 | 243 | Comparative Steel |
| A-16 | 0.41 | 2.30 | 0.35 | 0.007 | 0.003 | 0.48 | 0.20 | 0.001 | 0.035 | 0.0009 | 1.56 | 0.35 | 231 | Comparative Steel |
| A-17 | 0.42 | 1.95 | 0.25 | 0.005 | 0.002 | 0.48 | 0.92 | 0.100 | 0.002 | 0.0007 | 0.46 | 0.42 | 245 | Inventive Steel |
| A-18 | 0.42 | 2.05 | 0.45 | 0.005 | 0.003 | 0.40 | 0.35 | 0.035 | 0.001 | 0.0008 | 1.36 | 0.41 | 237 | Inventive Steel |
| A-19 | 0.36 | 2.00 | 0.63 | 0.004 | 0.002 | 0.25 | 0.21 | 0.180 | 0.002 | 0.0008 | 0.31 | 0.35 | 221 | Inventive Steel |
| A-20 | 0.41 | 2.00 | 0.95 | 0.006 | 0.004 | 0.11 | 0.20 | 0.200 | 0.002 | 0.0008 | 0.24 | 0.39 | 251 | Inventive Steel |
| A-21 | 0.38 | 2.40 | 0.99 | 0.005 | 0.003 | 0.45 | 0.12 | 0.200 | 0.050 | 0.0008 | 0.25 | 0.30 | 240 | Comparative Steel |
| A-22 | 0.44 | 1.75 | 0.89 | 0.004 | 0.004 | 0.21 | 0.44 | 0.001 | 0.090 | 0.0007 | 0.44 | 0.49 | 254 | Comparative Steel |
| A-23 | 0.44 | 2.00 | 0.89 | 0.006 | 0.003 | 0.05 | 0.92 | 0.001 | 0.130 | 0.0009 | 0.35 | 0.42 | 259 | Comparative Steel |
| A-24 | 0.44 | 2.20 | 0.89 | 0.006 | 0.003 | 0.05 | 0.92 | 0.210 | 0.002 | 0.0009 | 0.24 | 0.39 | 269 | Comparative Steel |
| A-25 | 0.41 | 2.29 | 0.33 | 0.006 | 0.004 | 0.47 | 0.15 | 0.001 | 0.036 | 0.0007 | 1.51 | 0.35 | 232 | Comparative Steel |
| A-26 | 0.37 | 1.90 | 0.21 | 0.008 | 0.006 | 0.11 | 0.21 | 0.115 | 0.115 | 0.0008 | 0.22 | 0.37 | 232 | Comparative Steel |
| A-27 | 0.40 | 2.33 | 0.99 | 0.005 | 0.003 | 0.45 | 0.12 | 0.190 | 0.050 | 0.0008 | 0.24 | 0.33 | 250 | Comparative Steel |
| A-28 | 0.43 | 1.76 | 0.89 | 0.006 | 0.005 | 0.21 | 0.44 | 0.001 | 0.090 | 0.0007 | 0.45 | 0.47 | 249 | Comparative Steel |
| A-29 | 0.44 | 2.00 | 0.89 | 0.007 | 0.004 | 0.05 | 0.21 | 0.020 | 0.085 | 0.0009 | 0.43 | 0.43 | 256 | Comparative Steel |
| A-30 | 0.35 | 1.84 | 0.91 | 0.005 | 0.001 | 0.05 | 0.21 | 0.035 | 0.001 | 0.0008 | 1.46 | 0.38 | 198 | Inventive Steel |

The spring steel samples were manufactured under the same conditions to investigate how the DF value, DT value and WD value affect decarburization resistance. The manufacturing conditions were as follows. First, cylindrical steel ingots (diameter: 200 mm, length: 400 mm) were obtained by steelmaking with vacuum melting, heated to 1000° C., and then subjected to hot rolling to be finished to wire rods having a diameter of 15 mm. In this case, the heating was performed in the air atmosphere. Samples for microstructure observation (diameter: 15 mm, length: 10 mm) were taken from the wire rods after being subjected to the hot rolling.

It should be noted that the decarburization resistance and toughness were evaluated by the testing method specified in the examples, which will be described later. While it is preferable that the toughness of spring steel samples is evaluated in the actually manufactured springs, in this case, the above-mentioned hot rolled wire rods having a diameter of 15 mm were used. Round bar test specimens having a diameter of 15 mm and a length of 100 mm were taken from the middle portions of these wire rods, and these specimens were subjected to quenching-tempering treatment. The quenching was performed at a heating temperature of 900° C. for a holding time of 15 minutes using oil cooling at 60° C., while the tempering was performed at a heating temperature of 350° C. for a holding time of 60 minutes using water cooling. These round bar test specimens subjected to the heat treatment were used for evaluation by the testing method specified in the examples described later.

In addition, the wire drawability in manufacturing springs was evaluated in the following way: steel ingots (diameter: 200 mm, length: 400 mm) were obtained by steelmaking with vacuum melting, heated to 1000° C., and then subjected to hot rolling to be finished to wire rods having a diameter of 13.5 mm, which wire rods were in turn drawn to a diameter of 12.6 mm, and evaluation was made based on the number of times these wire rods were broken when drawn to a length of 20 m.

Since Si facilitates generation of ferrite phase, C suppresses generation of ferrite phase, and Sb and Sn suppress a reduction in the C content in a surface layer, the ferrite decarburized depth was analyzed by using the DF value defined in Formula (1) above, assuming that the DF value might be used as an indicator of susceptibility to ferrite decarburization. As a result and as shown in Table 2 and FIG. 1, where the DF value is greater than 1.50, the C content in the surface layer of the spring decreased due to an increase in the amount of Si added and/or a reduction in the amount of C, Sn and Sb added, thereby causing ferrite decarburization and, consequently, lowering the decarburization resistance. On the other hand, where the DF value is less than 0.23, a decrease in the C content in the surface layer can be suppressed because of a reduction in the amount of Si added and/or an increase in the amount of C, Sn and Sb added, improving the decarburization resistance, in which case, however, a remarkable improvement was not observed. Further, where the DF value is less than 0.23, as mentioned above, the toughness tends to decrease due to an increase in the amount of C, Sn and Sb added. Based on this, we found that improvement of decarburization resistance and maintenance of toughness may be accomplished by adjusting the DF value between 0.23 and 1.50.

Similarly, as shown in Table 2, where the DT value defined in Formula (2) above is less than 0.34, the C content in the surface layer of the spring decreased due to an increase in the amount of Si added and/or a reduction in the amount of C, Sn and Sb added, thereby causing ferrite decarburization and, consequently, lowering the decarburization resistance. In contrast, where the DT value is greater than 0.46, supply of C to the surface layer of the spring was delayed due to an increase in the amount of Sn and Sb added, which results in enhanced, rather than suppressed, decarburization as deep as 0.1 mm or more. Based on this, we found that improvement of decarburization resistance is achieved by adjusting the DT value between 0.34 to 0.46.

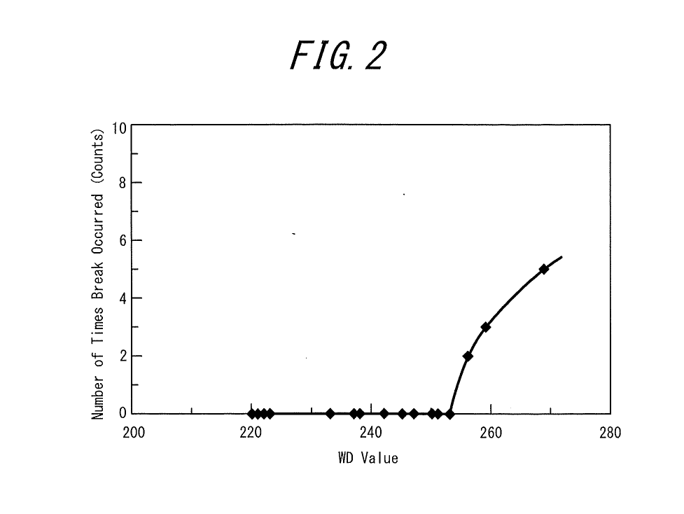

As described above, the decarburization resistance is improved by adjusting Sn content and/or Sb content. However, there was a concern that these elements might adversely affect the wire drawability as they enhance the quench hardenability and facilitate generation of bainite and martensite in the resulting wires (wire rods after hot rolling). Therefore, as mentioned earlier, investigations were made on the wire drawability to analyze how the content of C, Sb and Sn affects wire drawability. The results thereof are shown in Table 2 and FIG. 2. Plotted in FIG. 2 are only the results of those steel samples having DF values and DT values within our scope. As shown in Table 2 and FIG. 2, where the WD value defined in Formula (3) above is greater than 255, on one hand, there is an increase in the content of C, Sn or Sb, which leads to an increase in the hardness of the resulting wire and, on the other hand, the quench hardenability is enhanced by Sn or Sb, which leads to generation of hard phase such as bainite or martensite and, therefore, deteriorates the toughness and wire drawability.

In our spring steels, the WD value is smallest when the C content is 0.35 mass % and either Sb or Sn content is 0.035 mass %, in which case the WD value is 197. That is, in our spring steels, since the lower limits of C content and Sb or Sn content are specified, respectively, the WD value defined in Formula (3) above can only take a value not less than 197.

The smaller the WD value, the lower the C, Sn or Sb content. Thus, the hardness tends to decrease in manufacturing springs. In view of the above, the WD value is preferably not less than 220.

TABLE 2

| | Ferrite | | | Number of | | |
|---|---|---|---|---|---|---|
| | Decarburized | Decarburized | Toughness | Times Break | | |
| Steel | Depth | Depth | uE₂₀ | Occurred | Wire | |
| No. | (mm) | (mm) | (J/cm²) | (counts/20 m) | drawability | Remarks |
| A-1 | 0.11 | 0.15 | 13.3 | 1 | Poor | Reference Steel |
| A-2 | 0.00 | 0.02 | 45.7 | 0 | Good | Inventive Steel |
| A-3 | 0.00 | 0.01 | 49.8 | 0 | Good | Inventive Steel |
| A-4 | 0.00 | 0.02 | 51.3 | 0 | Good | Inventive Steel |
| A-5 | 0.00 | 0.03 | 47.7 | 0 | Good | Inventive Steel |
| A-6 | 0.00 | 0.02 | 45.4 | 0 | Good | Inventive Steel |
| A-7 | 0.00 | 0.02 | 45.5 | 0 | Good | Inventive Steel |
| A-8 | 0.00 | 0.03 | 46.7 | 0 | Good | Inventive Steel |
| A-9 | 0.00 | 0.04 | 45.6 | 0 | Good | Inventive Steel |
| A-10 | 0.00 | 0.02 | 45.1 | 0 | Good | Inventive Steel |
| A-11 | 0.00 | 0.03 | 47.4 | 0 | Good | Inventive Steel |
| A-12 | 0.00 | 0.02 | 49.9 | 0 | Good | Inventive Steel |
| A-13 | 0.00 | 0.03 | 51.1 | 0 | Good | Inventive Steel |
| A-14 | 0.00 | 0.02 | 46.9 | 0 | Good | Inventive Steel |
| A-15 | 0.00 | 0.07 | 15.3 | 6 | Poor | Comparative Steel |
| A-16 | 0.05 | 0.12 | 46.6 | 0 | Good | Comparative Steel |
| A-17 | 0.00 | 0.02 | 46.0 | 0 | Good | Inventive Steel |
| A-18 | 0.00 | 0.03 | 46.6 | 0 | Good | Inventive Steel |
| A-19 | 0.00 | 0.03 | 45.9 | 0 | Good | Inventive Steel |
| A-20 | 0.00 | 0.04 | 45.5 | 0 | Good | Inventive Steel |
| A-21 | 0.00 | 0.12 | 45.6 | 0 | Good | Comparative Steel |
| A-22 | 0.00 | 0.13 | 45.1 | 0 | Good | Comparative Steel |
| A-23 | 0.00 | 0.04 | 25.1 | 3 | Poor | Comparative Steel |
| A-24 | 0.00 | 0.04 | 24.6 | 5 | Poor | Comparative Steel |
| A-25 | 0.03 | 0.11 | 50.3 | 0 | Good | Comparative Steel |
| A-26 | 0.00 | 0.06 | 16.2 | 4 | Poor | Comparative Steel |
| A-27 | 0.02 | 0.09 | 45.9 | 0 | Good | Comparative Steel |
| A-28 | 0.00 | 0.11 | 45.7 | 0 | Good | Comparative Steel |
| A-29 | 0.00 | 0.05 | 26.3 | 2 | Poor | Comparative Steel |
| A-30 | 0.00 | 0.03 | 47.3 | 0 | Good | Inventive Steel |

Further, in addition to the aforementioned elements, from the viewpoint of enhancing the strength of steel, our spring steels may optionally contain the following elements:
at least one of Al: 0.50 mass % or less, Cu: 1.0 mass % or less, and Ni: 2.0 mass % or less.
   Copper (Cu) and nickel (Ni) are elements that each enhance quench hardenability and post-tempering strength of the steel, and may be selectively added to the steel. To obtain this effect, Cu and Ni are preferably added to the steel in an amount of 0.005 mass % or more, respectively. However, if Cu is added in an amount more than 1.0 mass % and Ni is added in an amount more than 2.0 mass %, then alloy cost increases rather than decreases. It is thus preferable that Cu is added in an amount up to 1.0 mass % and Ni is added in an amount up to 2.0 mass %.

Aluminum (Al) is an element useful as a deoxidizer and suppresses growth of austenite grains during quenching to effectively maintain the strength of the steel. Thus, Al may preferably be added to the steel in an amount of 0.01 mass % or more. However, if Al is added to the steel in an amount exceeding 0.50 mass %, the effect attained by addition of Al reaches a saturation point, which disadvantageously leads to an increase in cost and deterioration in the cold coiling properties of the steel. It is thus preferable that Al is added in an amount up to 0.50 mass %.

Further, in addition to the aforementioned elements, to enhance the strength of the steel, our spring steels may optionally contain the following elements:
at least one of W: 2.0 mass % or less, Nb: 0.1 mass % or less, Ti: 0.2 mass % or less, and V: 0.5 mass % or less.
   W, Nb, Ti and V are elements that each enhance quench hardenability and post-tempering strength of the steel, and may be selectively added to the steel depending on the required strength. To obtain this effect, it is preferable that W, Nb and Ti are added to the steel in an amount of 0.001 mass % or more, respectively, and that V is added to the steel in an amount of 0.002 mass % or more. However, if V is added in an amount exceeding 0.5 mass %, Nb is added in an amount exceeding 0.1 mass %, and Ti is added in an amount exceeding 0.2 mass %, then many carbides are generated in the steel, which results in excessively enhanced strength and lower toughness of the steel. It is thus preferable that Nb, Ti and V are each added in an amount up to the above-identified upper limit. Further, if W is added in an amount exceeding 2.0 mass %, the strength of the steel is enhanced to such an excessive degree that it deteriorates the toughness of the steel and increases the alloy cost. It is thus preferable that W is added in an amount up to 2.0 mass %.
   B≦0.005 mass %

Boron (B) is an element that increases quench hardenability of the steel and thereby enhances post-tempering strength thereof, and may be optionally contained in the steel. To obtain this effect, it is preferable that B is added in an amount of 0.0002 mass % or more. However, if added in an amount exceeding 0.005 mass %, B may deteriorate the cold work-ability of the steel. It is thus preferable that B is added in an amount of 0.005 mass % or less.

Any steel ingots may be used having the chemical compositions as described above, regardless of whether being obtained by steelmaking in a converter or by vacuum smelting. A material such as a steel ingot, slab, bloom or billet is subjected to heating, hot-rolling, pickling for scale removal and subsequent wire drawing to be finished to a drawn wire having a predetermined diameter, which is used as steel for springs.

The high strength spring steel thus obtained possesses excellent decarburization resistance and wire drawability despite its low manufacturing cost, and may be applied to, for example, suspension springs as underbody parts of automobiles.

### Examples

Steel samples having the chemical compositions shown in Table 3 (the value of each element in Table 3 represents the content (in mass %) of the element) were prepared by steelmaking in a converter to produce billets therefrom. These billets were heated to 1000° C. and subjected to hot rolling to be finished to wire rods having diameters of 15 mm and, for wire drawability evaluation purpose, 13.5 mm. While the heating was performed in an atmosphere of mixed gas (M gas) of blast furnace gas and coke oven gas, it may also be performed in other atmospheres (e.g., in air, LNG, city gas, mixed gas such as COG/BFG mixture gas, COG, heavy oil, nitrogen, argon, and so on). Samples for microstructure observation (diameter: 15 mm, length: 10 mm) were taken from the wire rods after being subjected to the hot rolling, and the decarburization resistance and toughness of the spring steel samples were determined. While it is preferable that the toughness of spring steel samples is evaluated in the actually manufactured springs, in this case, round bar test specimens having a diameter of 15 min and a length of 100 mm were taken from the above-mentioned wire rods having a diameter of 15 mm, and these specimens were subjected to quenching-tempering treatment. Quenching was performed at a heating temperature of 900° C. for a holding time of 15 minutes using oil cooling at 60° C., while tempering was performed at a heating temperature of 350° C. for a holding time of 60 minutes using water cooling. The obtained round bar test specimens were tested and evaluated in the following way.

TABLE 3

| Steel | | | | | | | | | | | | |
|---|---|---|---|---|---|---|---|---|---|---|---|---|
| No. | C | Si | Mn | P | S | Cr | Mo | Sn | Sb | O | Al | Cu |
| A-1 | 0.60 | 2.00 | 0.85 | 0.020 | 0.015 | — | — | 0.001 | 0.005 | 0.0010 | — | — |
| B-1 | 0.42 | 2.00 | 0.90 | 0.004 | 0.003 | 0.03 | 0.20 | 0.001 | 0.035 | 0.0009 | 0.03 | — |
| B-2 | 0.46 | 2.01 | 0.88 | 0.004 | 0.003 | 0.09 | 0.20 | 0.001 | 0.035 | 0.0008 | 0.03 | 0.02 |
| B-3 | 0.43 | 1.99 | 0.88 | 0.005 | 0.003 | 0.02 | 0.19 | 0.001 | 0.051 | 0.0008 | 0.03 | — |
| B-4 | 0.34 | 2.01 | 0.77 | 0.006 | 0.004 | 0.15 | 0.20 | 0.001 | 0.035 | 0.0009 | — | — |
| B-5 | 0.41 | 2.01 | 0.89 | 0.004 | 0.002 | 0.03 | 0.21 | 0.001 | 0.110 | 0.0009 | 0.03 | — |
| B-6 | 0.36 | 1.89 | 0.21 | 0.005 | 0.003 | 0.49 | 0.51 | 0.110 | 0.110 | 0.0008 | 0.03 | 0.25 |
| B-7 | 0.43 | 2.40 | 0.25 | 0.004 | 0.002 | 0.35 | 0.11 | 0.035 | 0.120 | 0.0007 | 0.03 | 0.50 |
| B-8 | 0.38 | 1.99 | 0.77 | 0.006 | 0.003 | 0.25 | 0.05 | 0.001 | 0.130 | 0.0007 | 0.04 | — |
| B-9 | 0.42 | 2.08 | 0.68 | 0.007 | 0.002 | 0.35 | 0.06 | 0.020 | 0.034 | 0.0008 | 0.03 | — |
| B-10 | 0.36 | 1.76 | 0.45 | 0.005 | 0.003 | 0.48 | 0.71 | 0.090 | 0.120 | 0.0007 | 0.06 | 0.25 |
| B-11 | 0.40 | 2.18 | 0.35 | 0.004 | 0.004 | 0.47 | 0.11 | 0.001 | 0.035 | 0.0008 | 0.02 | — |
| B-12 | 0.39 | 2.01 | 0.45 | 0.005 | 0.003 | 0.48 | 0.21 | 0.140 | 0.120 | 0.0007 | 0.03 | — |
| B-13 | 0.44 | 2.40 | 0.13 | 0.004 | 0.002 | 0.35 | 0.06 | 0.035 | 0.090 | 0.0006 | 0.02 | 0.25 |
| B-14 | 0.41 | 1.95 | 0.56 | 0.007 | 0.003 | 0.42 | 0.22 | 0.150 | 0.045 | 0.0008 | 0.03 | — |
| B-15 | 0.38 | 1.99 | 0.70 | 0.008 | 0.004 | 0.25 | 0.21 | 0.001 | 0.120 | 0.0007 | 0.03 | — |
| B-16 | 0.39 | 2.05 | 0.88 | 0.007 | 0.003 | 0.15 | 0.60 | 0.035 | 0.035 | 0.0008 | 0.03 | 0.35 |
| B-17 | 0.42 | 2.00 | 0.88 | 0.004 | 0.003 | 0.51 | 0.20 | 0.001 | 0.035 | 0.0008 | 0.03 | — |
| B-18 | 0.36 | 2.00 | 0.75 | 0.005 | 0.002 | 0.15 | 0.20 | 0.185 | 0.050 | 0.0007 | 0.02 | — |
| B-19 | 0.44 | 1.89 | 0.92 | 0.005 | 0.002 | 0.15 | 0.18 | 0.001 | 0.035 | 0.0007 | 0.03 | — |
| B-20 | 0.40 | 1.75 | 0.88 | 0.007 | 0.003 | 0.25 | 0.13 | 0.001 | 0.035 | 0.0008 | 0.02 | — |
| B-21 | 0.41 | 2.40 | 0.87 | 0.006 | 0.004 | 0.25 | 0.15 | 0.005 | 0.035 | 0.0009 | 0.02 | — |
| B-22 | 0.43 | 2.01 | 0.10 | 0.006 | 0.002 | 0.45 | 0.11 | 0.001 | 0.035 | 0.0011 | — | 0.10 |
| B-23 | 0.40 | 2.00 | 1.00 | 0.005 | 0.005 | 0.15 | 0.09 | 0.001 | 0.037 | 0.0012 | — | — |
| B-24 | 0.41 | 2.00 | 0.90 | 0.025 | 0.004 | 0.01 | 0.21 | 0.001 | 0.083 | 0.0008 | 0.03 | — |
| B-25 | 0.41 | 1.99 | 0.89 | 0.009 | 0.025 | 0.04 | 0.22 | 0.001 | 0.075 | 0.0007 | 0.02 | — |
| B-26 | 0.43 | 2.25 | 0.91 | 0.008 | 0.003 | 0.48 | 0.01 | 0.001 | 0.110 | 0.0006 | 0.02 | — |
| B-27 | 0.37 | 1.75 | 0.10 | 0.007 | 0.006 | 0.01 | 1.00 | 0.077 | 0.115 | 0.0013 | — | — |
| B-28 | 0.38 | 2.10 | 0.77 | 0.006 | 0.005 | 0.02 | 0.23 | 0.001 | 0.120 | 0.0007 | 0.02 | — |
| B-29 | 0.44 | 2.43 | 0.88 | 0.013 | 0.008 | 0.15 | 0.21 | 0.001 | 0.041 | 0.0007 | 0.02 | — |
| B-30 | 0.44 | 2.38 | 1.10 | 0.012 | 0.007 | 0.21 | 0.17 | 0.001 | 0.037 | 0.0012 | — | — |
| B-31 | 0.42 | 2.01 | 0.90 | 0.027 | 0.005 | 0.15 | 0.08 | 0.001 | 0.036 | 0.0011 | — | 0.04 |
| B-32 | 0.43 | 1.99 | 0.87 | 0.005 | 0.027 | 0.33 | 0.07 | 0.001 | 0.042 | 0.0008 | 0.03 | — |
| B-33 | 0.41 | 1.79 | 0.67 | 0.006 | 0.004 | 0.41 | 1.03 | 0.001 | 0.037 | 0.0008 | 0.02 | — |
| B-34 | 0.42 | 2.01 | 0.92 | 0.005 | 0.004 | 0.03 | 0.21 | 0.050 | 0.002 | 0.0007 | 0.04 | — |
| B-35 | 0.41 | 1.99 | 0.85 | 0.005 | 0.004 | 0.25 | 0.18 | 0.130 | 0.002 | 0.0006 | 0.03 | 0.15 |
| B-36 | 0.42 | 2.00 | 0.91 | 0.003 | 0.005 | 0.03 | 0.22 | 0.035 | 0.002 | 0.0007 | 0.04 | 0.20 |
| B-37 | 0.42 | 2.03 | 0.83 | 0.006 | 0.003 | 0.03 | 0.18 | 0.190 | 0.002 | 0.0007 | 0.03 | 0.20 |
| B-38 | 0.39 | 1.99 | 0.82 | 0.005 | 0.005 | 0.49 | 0.05 | 0.080 | 0.001 | 0.0006 | 0.03 | — |
| B-39 | 0.42 | 2.18 | 0.80 | 0.006 | 0.005 | 0.25 | 0.12 | 0.210 | 0.002 | 0.0007 | 0.02 | 0.10 |
| B-40 | 0.42 | 2.00 | 0.89 | 0.005 | 0.005 | 0.25 | 0.15 | 0.034 | 0.001 | 0.0006 | 0.02 | 0.10 |

| Steel | | | | | | | DF | DT | WD | |
|---|---|---|---|---|---|---|---|---|---|---|
| No. | Ni | W | Nb | Ti | V | B | Value | Value | Value | Remarks |
| A-1 | — | — | — | — | — | — | 5.56 | 0.60 | 327 | Reference Steel |
| B-1 | — | — | — | 0.021 | — | 0.0020 | 1.32 | 0.42 | 233 | Inventive Steel |
| B-2 | 0.02 | — | — | 0.035 | — | — | 1.21 | 0.45 | 254 | Comparative Steel |
| B-3 | — | — | — | 0.018 | — | 0.0019 | 0.89 | 0.43 | 240 | Inventive Steel |
| B-4 | — | — | — | — | — | — | 1.64 | 0.33 | 189 | Comparative Steel |
| B-5 | — | — | — | 0.021 | — | 0.0022 | 0.44 | 0.39 | 236 | Inventive Steel |
| B-6 | 0.50 | — | — | 0.033 | — | — | 0.24 | 0.36 | 222 | Inventive Steel |
| B-7 | 1.00 | — | — | 0.025 | — | — | 0.36 | 0.35 | 252 | Inventive Steel |
| B-8 | — | — | — | — | — | — | 0.40 | 0.37 | 222 | Comparative Steel |
| B-9 | — | — | — | — | — | — | 0.92 | 0.40 | 235 | Comparative Steel |
| B-10 | 0.50 | 0.60 | — | 0.075 | 0.30 | 0.0019 | 0.23 | 0.39 | 221 | Inventive Steel |
| B-11 | — | — | — | 0.031 | — | — | 1.51 | 0.36 | 222 | Comparative Steel |
| B-12 | — | — | — | — | — | — | 0.20 | 0.36 | 243 | Comparative Steel |
| B-13 | 0.50 | 0.30 | 0.05 | 0.021 | 0.15 | 0.0020 | 0.44 | 0.36 | 254 | Inventive Steel |
| B-14 | — | — | 0.03 | 0.065 | — | — | 0.24 | 0.40 | 246 | Inventive Steel |
| B-15 | — | — | — | 0.025 | — | 0.0025 | 0.43 | 0.37 | 221 | Inventive Steel |
| B-16 | 0.50 | — | — | 0.101 | 0.05 | 0.0015 | 0.75 | 0.37 | 220 | Inventive Steel |
| B-17 | — | — | — | 0.020 | — | 0.0015 | 1.32 | 0.42 | 233 | Comparative Steel |
| B-18 | — | — | — | — | — | — | 0.24 | 0.34 | 224 | Inventive Steel |
| B-19 | — | — | — | — | — | — | 1.19 | 0.46 | 244 | Inventive Steel |
| B-20 | — | — | 0.01 | — | — | — | 1.22 | 0.45 | 222 | Inventive Steel |
| B-21 | — | 0.01 | — | — | — | — | 1.46 | 0.34 | 228 | Inventive Steel |
| B-22 | 0.15 | — | — | — | — | — | 1.30 | 0.42 | 238 | Inventive Steel |
| B-23 | — | — | — | 0.025 | 0.05 | 0.0011 | 1.32 | 0.40 | 222 | Inventive Steel |
| B-24 | — | — | — | 0.021 | — | 0.0021 | 0.58 | 0.40 | 233 | Inventive Steel |
| B-25 | — | — | — | — | — | — | 0.64 | 0.40 | 232 | Inventive Steel |
| B-26 | — | — | — | 0.021 | | 0.0018 | 0.47 | 0.37 | 247 | Inventive Steel |
| B-27 | — | 0.15 | 0.02 | — | — | — | 0.25 | 0.40 | 224 | Inventive Steel |
| B-28 | — | — | — | — | — | — | 0.46 | 0.35 | 221 | Inventive Steel |
| B-29 | — | — | — | — | — | — | 1.31 | 0.36 | 244 | Comparative Steel |
| B-30 | — | — | — | — | — | — | 1.42 | 0.37 | 244 | Comparative Steel |
| B-31 | 0.02 | — | — | — | — | — | 1.29 | 0.41 | 233 | Comparative Steel |
| B-32 | — | — | 0.03 | — | — | — | 1.08 | 0.43 | 239 | Comparative Steel |
| B-33 | — | — | — | — | — | — | 1.15 | 0.45 | 228 | Comparative Steel |
| B-34 | — | — | — | 0.025 | — | 0.0021 | 0.92 | 0.41 | 235 | Inventive Steel |
| B-35 | 0.15 | — | — | — | 0.15 | — | 0.37 | 0.40 | 239 | Inventive Steel |
| B-36 | 0.20 | — | — | 0.030 | — | 0.0020 | 1.29 | 0.42 | 233 | Inventive Steel |
| B-37 | 0.20 | — | — | 0.030 | — | 0.0018 | 0.25 | 0.40 | 251 | Inventive Steel |
| B-38 | — | 0.20 | 0.02 | — | — | — | 0.63 | 0.39 | 222 | Inventive Steel |
| B-39 | 0.10 | — | — | — | — | — | 0.24 | 0.37 | 253 | Comparative Steel |
| B-40 | 0.10 | — | — | — | — | — | 1.36 | 0.42 | 233 | Comparative Steel |

### Decarburization Resistance

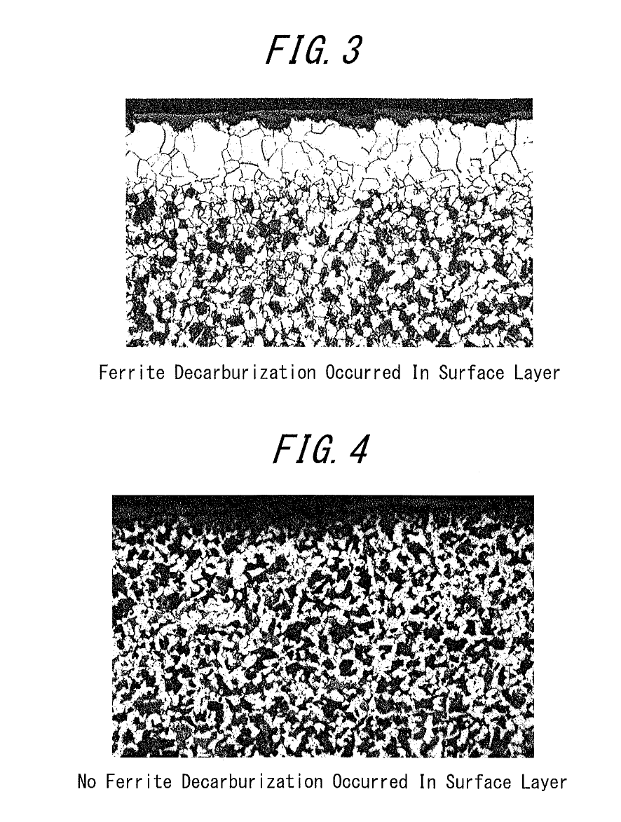

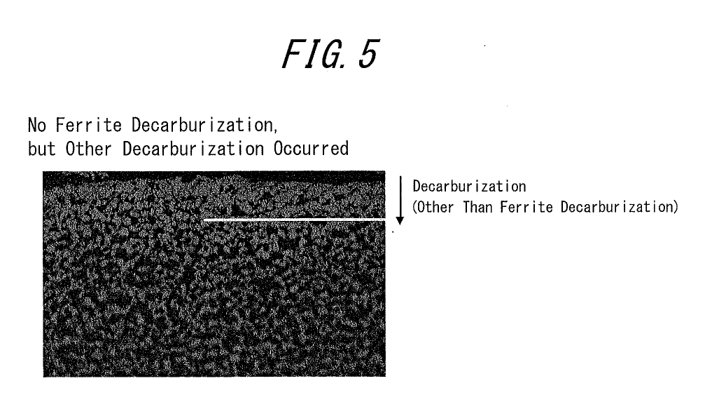

Decarburization resistance was determined by the presence or absence of ferrite single-phase microstructures in surface layers of the wire rods after being subjected to the hot rolling. The evaluation was performed according to JIS G0558 in the following way. Each wire rod after the hot rolling was cut into 10-mm long pieces in the longitudinal direction (rolling direction). To observe the microstructures of the cutting planes (cross-sections perpendicular to the longitudinal direction; hereinafter “C cross-sections”), the cut pieces were embedded in resin, mirror polished and then etched with 3% nital, respectively, to observe the microstructures of the surface layers of the C cross-sections. When any ferrite single-phase microstructure as shown in FIG. 3 appeared in the surface layer, it was assumed that ferrite decarburization occurred and the deepest portion of the ferrite decarburized layer was defined as the ferrite decarburized depth. In addition, when the microstructure appeared as shown in FIG. 4, it was defined as absence of ferrite decarburization. Further, when the microstructure appeared as shown in FIG. 5, i.e., any region with a low pearlite fraction was present in the surface layer, we assumed that decarburization occurred although no ferrite decarburized layer was observed, and it was determined that good decarburization resistance could be obtained if the thickness of that region was less than 0.1 mm.

### Toughness

Toughness was evaluated by using three 2-mm U-notched Charpy impact test specimens (height: 10 mm, width: 10 mm, length: 55 mm, notch depth: 2 mm, notch bottom radius: 1 mm), according to JIS Z 2242, with a test temperature of 20° C., to calculate the absorbed energy of the respective test specimens, the values of which were divided by 0.8, respectively, and the obtained results were determined as impact values (J/cm²). Then, the impact values of the three impact test specimens were averaged.

Since toughness is one of the properties required for spring steels, we determined that the test specimen showed a decrease in toughness if the toughness did not exceed twice the toughness of the reference steel.

### Wire Drawability

Wire drawability was evaluated in the following way: the above-mentioned wire rods having a diameter of 13.5 mm were drawn to a diameter of 12.6 mm and evaluated for their wire drawability based on the number of times these wire rods were broken when drawn to a length of 20 m. Once such a break occurred, we determined that the test specimen showed a decrease in the wire drawability.

Table 4 illustrates the evaluation results of ferrite decarburized depth and toughness (impact resistance). It can be seen that steel samples indicated by steel sample Nos. B-1, B-3, B-5 to B-7, B-10, B-13 to B-16, B-18 to B-28 and B-34 to B-38 that satisfy our conditions of the chemical compositions, DF value, DT value and WD value involves: no ferrite decarburization; decarburization as narrow as 0.1 mm or less; no break during drawing; good decarburization resistance; good wire drawability; and good toughness. In contrast, those steel samples indicated by steel sample Nos. B-2, B-4, B-8 to B-9, B-17, B-29 to B-33 and B-39 to B-40 that have chemical compositions out of our scope, as well as those steel samples indicated by steel sample Nos. B-11 to B-12 that have chemical compositions within our scope, but have DF values out of our scope involve a ferrite decarburized layer, or a decarburized layer as deep as 0.1 mm or more, or a decrease in the wire drawability.

TABLE 4

| | Ferrite | | | Number of | | |
|---|---|---|---|---|---|---|
| | Decarburized | Decarburized | Toughness | Times Break | | |
| Steel | Depth | Depth | uE₂₀ | Occurred | Wire | |
| No. | (mm) | (mm) | (J/cm²) | (counts/20 m) | drawability | Remarks |
| A-1 | 0.11 | 0.15 | 13.3 | 1 | Poor | Reference Steel |
| B-1 | 0.00 | 0.03 | 49.4 | 0 | Good | Inventive Steel |
| B-2 | 0.00 | 0.02 | 19.5 | 2 | Poor | Comparative Steel |
| B-3 | 0.00 | 0.03 | 50.0 | 0 | Good | Inventive Steel |
| B-4 | 0.09 | 0.15 | 50.1 | 0 | Good | Comparative Steel |
| B-5 | 0.00 | 0.02 | 48.9 | 0 | Good | Inventive Steel |
| B-6 | 0.00 | 0.03 | 50.1 | 0 | Good | Inventive Steel |
| B-7 | 0.00 | 0.02 | 47.9 | 0 | Good | Inventive Steel |
| B-8 | 0.00 | 0.11 | 19.7 | 2 | Poor | Comparative Steel |
| B-9 | 0.02 | 0.05 | 45.3 | 0 | Good | Comparative Steel |
| B-10 | 0.00 | 0.02 | 47.7 | 0 | Good | Inventive Steel |
| B-11 | 0.07 | 0.10 | 50.4 | 0 | Good | Comparative Steel |
| B-12 | 0.00 | 0.11 | 19.9 | 1 | Poor | Comparative Steel |
| B-13 | 0.00 | 0.02 | 50.3 | 0 | Good | Inventive Steel |
| B-14 | 0.00 | 0.03 | 49.1 | 0 | Good | Inventive Steel |
| B-15 | 0.00 | 0.05 | 49.7 | 0 | Good | Inventive Steel |
| B-16 | 0.00 | 0.04 | 47.0 | 0 | Good | Inventive Steel |
| B-17 | 0.00 | 0.02 | 21.3 | 1 | Poor | Comparative Steel |
| B-18 | 0.00 | 0.05 | 46.9 | 0 | Good | Inventive Steel |
| B-19 | 0.00 | 0.03 | 32.5 | 0 | Good | Inventive Steel |
| B-20 | 0.00 | 0.02 | 50.7 | 0 | Good | Inventive Steel |
| B-21 | 0.00 | 0.03 | 32.3 | 0 | Good | Inventive Steel |
| B-22 | 0.00 | 0.02 | 51.1 | 0 | Good | Inventive Steel |
| B-23 | 0.00 | 0.03 | 35.2 | 0 | Good | Inventive Steel |
| B-24 | 0.00 | 0.04 | 30.5 | 0 | Good | Inventive Steel |
| B-25 | 0.00 | 0.04 | 31.9 | 0 | Good | Inventive Steel |
| B-26 | 0.00 | 0.05 | 46.5 | 0 | Good | Inventive Steel |
| B-27 | 0.00 | 0.06 | 30.9 | 0 | Good | Inventive Steel |
| B-28 | 0.00 | 0.05 | 30.7 | 0 | Good | Inventive Steel |
| B-29 | 0.01 | 0.08 | 24.3 | 2 | Poor | Comparative Steel |
| B-30 | 0.00 | 0.03 | 23.1 | 2 | Poor | Comparative Steel |
| B-31 | 0.00 | 0.02 | 19.5 | 2 | Poor | Comparative Steel |
| B-32 | 0.00 | 0.05 | 21.2 | 2 | Poor | Comparative Steel |
| B-33 | 0.00 | 0.04 | 24.2 | 2 | Poor | Comparative Steel |
| B-34 | 0.00 | 0.02 | 43.3 | 0 | Good | Inventive Steel |
| B-35 | 0.00 | 0.03 | 41.5 | 0 | Good | Inventive Steel |
| B-36 | 0.00 | 0.02 | 43.6 | 0 | Good | Inventive Steel |
| B-37 | 0.00 | 0.05 | 39.5 | 0 | Good | Inventive Steel |
| B-38 | 0.00 | 0.04 | 39.9 | 0 | Good | Inventive Steel |
| B-39 | 0.00 | 0.11 | 23.5 | 3 | Poor | Comparative Steel |
| B-40 | 0.01 | 0.07 | 44.2 | 0 | Good | Comparative Steel |

1. A spring steel comprising a chemical composition comprising:
C: 0.35 mass % or more and 0.45 mass % or less,
Si: 1.75 mass % or more and 2.40 mass % or less,
Mn: 0.1 mass % or more and 1.0 mass % or less,
Cr: 0.01 mass % or more and less than 0.50 mass %,
Mo: 0.01 mass % or more and 1.00 mass % or less,
P: 0.025 mass % or less,
S: 0.025 mass % or less,
O: 0.0015 mass % or less, and
at least one selected from:
Sb: 0.035 mass % or more and 0.12 mass % or less and
Sn: 0.035 mass % or more and 0.20 mass % or less,
under conditions that
a DF value calculated by Formula (1) is 0.23 or more and 1.50 or less,
a DT value calculated by Formula (2) is 0.34 or more and 0.46 or less, and
a WD value calculated by Formula (3) is not more than 255; and
the balance being Fe and incidental impurities,
DF=[Si]/{100×[C]×([Sn]+[Sb])} (1)
DT=10×[C]/{5×[Si]+2×[Sn]+3×[Sb]} (2)
WD=544×[C]+188×[Sn+Sb] (3),
where [brackets] is the content of an element in the brackets in mass %.

2. The spring steel according to claim 1, wherein the chemical composition further comprises at least one element selected from
Al: 0.50 mass % or less,
Cu: 1.0 mass % or less, and
Ni: 2.0 mass % or less.

3. The spring steel according to claim 1, wherein the chemical composition further comprises at least one element selected from
W: 2.0 mass % or less,
Nb: 0.1 mass % or less,
Ti: 0.2 mass % or less, and
V: 0.5 mass % or less.

4. The spring steel according to claim 1, wherein the chemical composition further comprises
B: 0.005 mass % or less.

5. The spring steel according to claim 2, wherein the chemical composition further comprises at least one element selected from
W: 2.0 mass % or less,
Nb: 0.1 mass % or less,
Ti: 0.2 mass % or less, and
V: 0.5 mass % or less.

6. The spring steel according to claim 2, wherein the chemical composition further comprises
B: 0.005 mass % or less.

7. The spring steel according to claim 3, wherein the chemical composition further comprises
B: 0.005 mass % or less.

8. The spring steel according to claim 5, wherein the chemical composition further comprises
B: 0.005 mass % or less.
